(19) United States
(12) Patent Application Publication
(10) Pub. No.: US 2008/0189626 A1
(43) Pub. Date: Aug. 7, 2008

(54) Web Browser Document Modifier

(75) Inventor: Daryl David Coutts, Edmonton (CA)

Correspondence Address: Daryl Coutts, Suite 207, 11103 84 Ave, Edmonton, AB, T6G 2X4, omitted

(73) Assignee: Marengo Intellectual Property Ltd., Edmonton (CA)

(21) Appl. No.: 12/044,934

(22) Filed: Mar. 8, 2008

Related U.S. Application Data
(60) Provisional application No. 60/905,905, filed on Mar. 9, 2007.

(51) Int. Cl. G06F 3/00

(52) U.S. Cl. 715/760

(57) ABSTRACT

An apparatus and method for modifying a document associated with a web browser is described.

### CROSS REFERENCE TO RELATED APPLICATIONS

This application claims the benefit of priority under 35 USC 119(e) to U.S. Provisional Application No. 60/905,905, filed Mar. 9, 2007, entitled “Web Browser Document Modifier”, all of which is incorporated herein by reference in its entirety.

### TECHNICAL FIELD

The invention relates to apparatus and methods that replace advertisements in web browser documents on client computing devices.

### BACKGROUND OF THE INVENTION

Internet advertising is an important part of a computer user's online experience. Often, useful information on the internet is provided concurrently with advertising in order to pay for the development and presentation of the information. However, some advertising on the internet can be more racy than what the computer user desires. Also, some advertising on the internet can be too obtrusive for the computer user, which impedes the computer user in obtaining useful information. Further, display area is always at a premium, if an ad in a document could be replaced with a view of a computer user's email inbox, a computer user could attend to more tasks at the same time.

What is needed are apparatus and methods that replace ads in web browser documents to free up valuable screen space for other functions such as viewing emails and instant messaging conversations or ads that are more pertinent and appropriate for a computer user. What is needed is a web browser document modifier.

### BRIEF SUMMARY OF THE INVENTION

A web browser is available on a client computing device. A computer program product running on the client computing device is configured to interact with a document associated with the web browser. The computer program product detects HTML (Hyper Text Markup Language) associated with an advertisement in the document by determining if a first string associated with the document contains information related to the display size of a first HTML element. The detection of advertising related HTML can optionally be refined further by parsing the first string for ad related character sequences. If HTML associated with an advertisement is detected, an attribute of the first or a second HTML element can be set to HTML corresponding to a computer user's email inbox or an alternative advertisement or any other suitable HTML.

In another aspect of the invention, the document has first text that is visible when the document is displayed in the web browser. Also, the document has a corresponding URI (Uniform Resource Identifier). If the computer program product determines that the document's corresponding URI contains a particular character sequence, the computer program product modifies the document such that a portion of the first text will no longer be visible when the document is displayed and second text is added to the document, the second text is visible when the document is displayed. The second text can correspond to the computer user's email inbox, an alternative text advertisement or any other suitable text.

The computer program product may be integrated into the web browser or it can run as a separate application. Other objects, features and advantages of the present invention will become apparent upon perusal of the following description in conjunction with the appended drawings.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 illustrates an exemplary block diagram of several software modules running on a computing device, including a software module that represents a web browser document modifier.

FIG. 2 illustrates the replacement of a banner ad with a view of the computer user's inbox.

FIG. 3 illustrates an exemplary method that can be used to detect advertising related HTML in a document and modify the document to use alternative HTML.

FIG. 4 illustrates an exemplary method that can be used to modify the text of documents with corresponding URIs containing particular character sequences.

### DESCRIPTION OF EMBODIMENTS

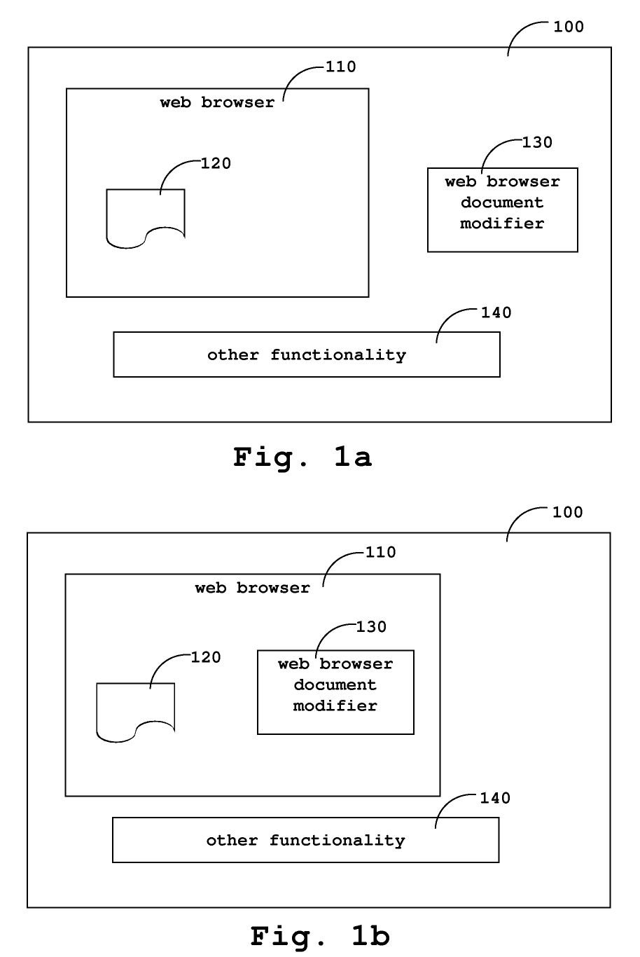

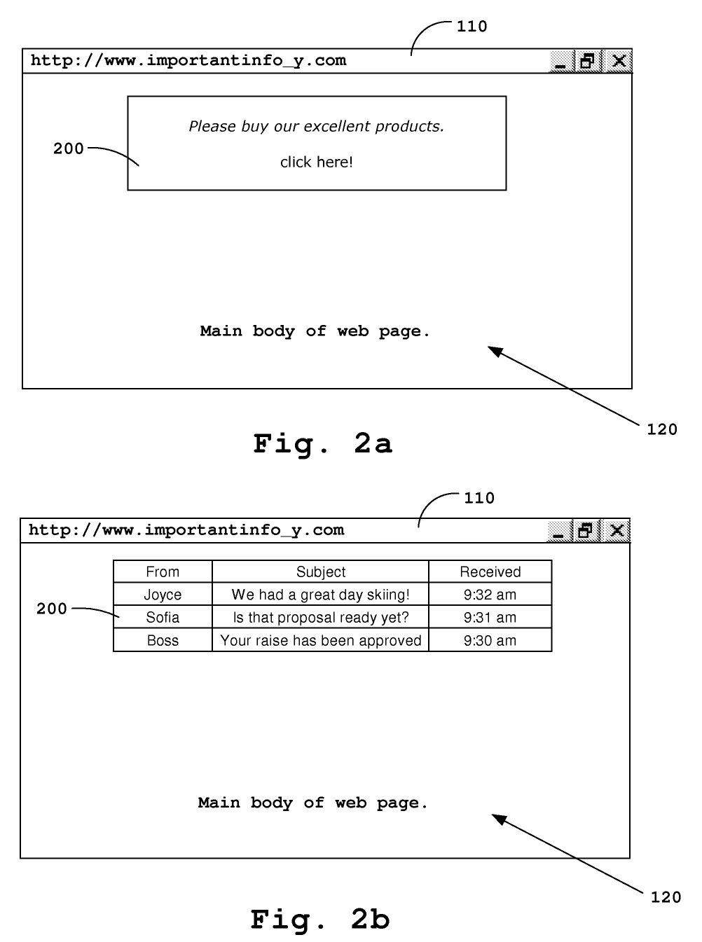

FIG. 1a is a block diagram of several software modules running on a computing device 100. The computing device 100 can be any computing device such as a desktop computer, notebook computer, cellphone, personal digital assistant, handheld computer or set top box. The computing device 100 has memory, not shown, that can be permanent or temporary or both permanent and temporary. The computing device 100 also has an associated display that is not shown in FIG. 1. Block 110 represents a web browser. Block 120 represents a document associated with the web browser 110. Block 130 is a web browser document modifier that modifies the document 120 based on certain conditions. The functionality of block 130 is discussed later in the discussion of FIG. 2 through FIG. 4. FIG. 1a illustrates that the web browser document modifier 130 functionality can be provided as a separate application from the web browser 110. FIG. 1b illustrates that the web browser document modifier 130 functionality may be integrated into the web browser 110 as an add-on, toolbar or extension or as part of the web browser 110 application itself. Block 140 represents other software modules executing on the computing device 100 such as the operating system and communication system.

FIG. 2a illustrates the web browser 110 displaying the document 120. The document comprises an HTML element 200. In FIG. 2a, the HTML element 200 has HTML that is associated with an advertisement. In FIG. 2a, the HTML element comprises an IFRAME tag with display size attribute “width=728” and an attribute “height=90”. FIG. 2a is one example, the HTML element 200 may have different attributes. The Internet Advertising Bureau (IAB) publishes standard ad sizes such as 468×60, 234×60, 88×31, 120×90, 120×60, 120×240, 125×125, 160×600, 300×250, 250×250, 240×400, 336×280, 180×150, 728×90, and 1×1. The HTML element 200 may have attributes that correspond to an IAB standard display size or any other size. The HTML element 200 can be any XHTML (eXtensible HyperText Markup Language) tag or any other type of markup language tag. The HTML element 200 can be any type of tag within a particular markup language. If the HTML element 200 is an HTML tag it could be an IFRAME tag as illustrated in FIG. 2a or it could be an OBJECT tag or an A tag or any type of HTML tag. For the purposes of this document, the words attribute and property can be used interchangeably.

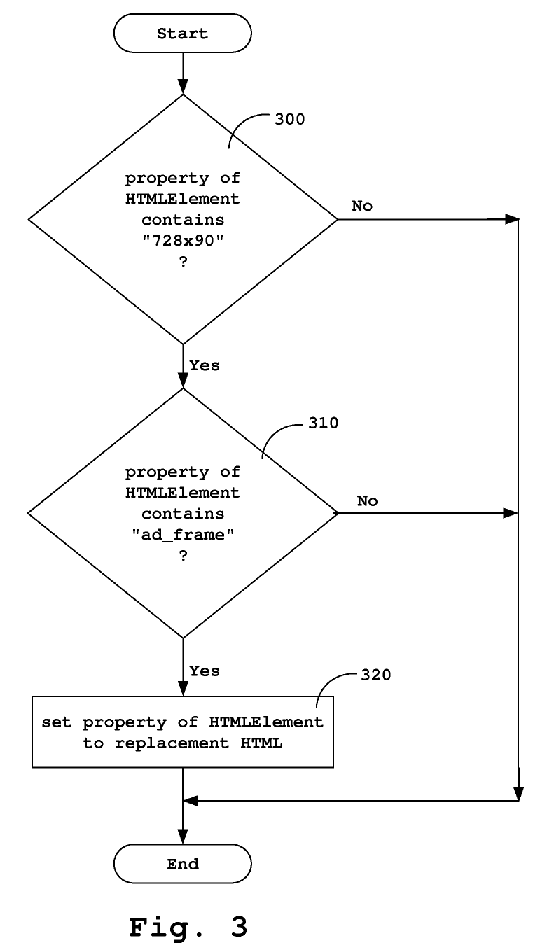

FIG. 2b illustrates the web browser 110 displaying the document 120. Now the HTML element 200 has HTML that is associated with an email inbox. A computer user is now able to obtain information from the document 120, while still monitoring their email inbox. The process for how the example in FIG. 2b is achieved is discussed later in the discussion of FIG. 3. FIG. 2b is just one example, the document 120 can be modified so that an instant message conversation is displayed instead of the original advertisement or any other type of information that may be useful for display. Even an alternate advertisement may be displayed instead of the original advertisement.

FIG. 3 illustrates a method that can be implemented to detect HTML (or any other markup language) associated with an advertisement and then modify the HTML such that alternative information can be displayed. In block 300, a property or attribute of the HTML element 200 is checked to see if it contains a character sequence that relates to a display size for an advertisement. The property or attribute of the HTML element 200 can be examined as a string, so the check is a string comparison to a particular character sequence. If the string comparison matches, the example in FIG. 3 is “728×90”, further checking can be done, block 310 (optional), to make sure the HTML element 200 is associated with an advertisement. If the HTML element 200 has an attribute that contains a character sequence such as “ad_banner” or “ad_frame” or other type of character sequence, this refines the determination that the HTML element 200 has HTML that is associated with an advertisement. The character sequences described herein and in the figures are examples only, any character sequence may be used for comparison to determine if the HTML element 200 has HTML that is associated with an advertisement. In block 320, an attribute of the HTML element 200 is set—this could be to HTML that will display a view of an email inbox or even an alternative ad or any other markup language. Also, in block 320, an attribute of a different HTML element 200 may be set.

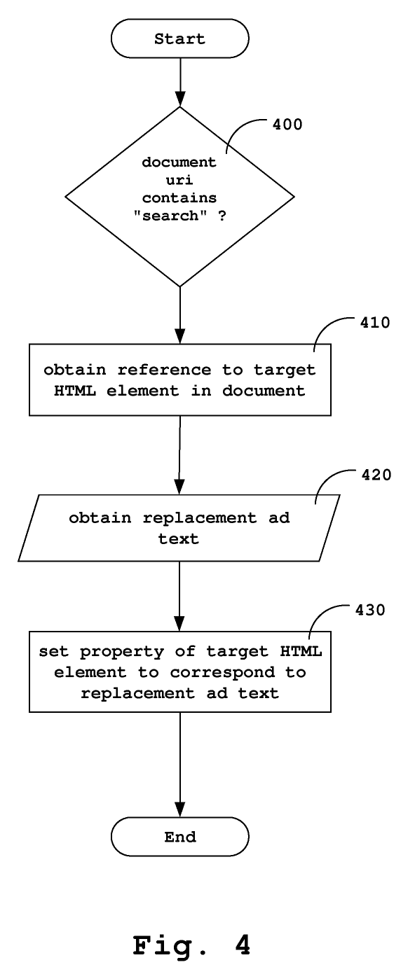

FIG. 2 and FIG. 3 illustrated modifying HTML elements 200 associated with banner type advertisements. FIG. 4 illustrates modifying HTML elements 200 associated with text ads. In block 400 the URI of the document 120 is checked to see if it has a certain character sequence, it could be checked against any character sequence. A few examples are “search”, “search?”, “result”, “results”, “results?”, “goggle”, “yehoo”, and “life”. If the check in block 400 is positive, the method continues at block 410. In block 410, a reference is obtained to a target HTML tag in the document 120. In block 420, replacement ad text is obtained. The replacement ad text may be obtained from a server. In block 430, an attribute or property of the target HTML tag is set to correspond to the replacement ad text.

The functionality described herein may be implemented in a web browser add-on, add-in, extension, plug-in, helper object or any other type of application function extender. Computer executable instructions for carrying out the method illustrated in FIG. 3 and FIG. 4 may be stored on any suitable media readable by a computer such as floppy disks, hard disks, CD-ROMS, DVDs, Flash ROMs, non-volatile ROM and RAM.

While various embodiments have been described above, it should be understood that it has been presented by way of example only, and not limitation. For instance, instead of an HTML element, an XHTML element could be used.

I claim:

1. A method of detecting HTML associated with an advertisement, the method comprising:
determining if a first string contains information related to the display size of a first HTML element.

2. The method of claim 1 wherein if the first string contains information related to the display size of the first HTML element, setting a property of a second HTML element.

3. The method of claim 2 wherein setting a property of the second HTML element comprises setting a property of the first HTML element.

4. The method of claim 1 wherein determining if the first string contains information related to the display size of the first HTML element comprises determining if the first HTML string contains information corresponding to one of the IAB standard ad dimensions.

5. The method of claim 1 wherein determining if the first HTML string contains information related to the display size of the first HTML element comprises determining if the first HTML string contains information corresponding to an ad dimension selected from the list of 468×60, 234×60, 88×31, 120×90, 120×60, 120×240, 125×125, 160×600, 300×250, 250×250, 240×400, 336×280, 180×150, 728×90 and 1×1.

6. The method of claim 1 further comprising determining if the first HTML string contains information related to a particular sequence of characters.

7. The method of claim 6 wherein the particular sequence is one selected from the list of “ad_frame”, “ad_banner”, “ad”, “default_ad”, “page_ad”, “ad_url” and “banner”.

8. An add-on for a web browser, where the add-on performs a method of determining if a first string contains information related to the display size of a first HTML element.

9. The add-on in claim 8 wherein the method it performs if the first string contains information related to the display size of the first HTML element, setting a property of a second HTML element.

10. The add-on in claim 9 wherein the method it performs setting a property of the second HTML element comprises setting a property of the first HTML element.

11. The add-on in claim 8 wherein the method it performs determining if the first string contains information related to the display size of the first HTML element comprises determining if the first HTML string contains information corresponding to one of the IAB standard ad dimensions.

12. The add-on in claim 8 wherein the method it performs determining if the first HTML string contains information related to the display size of the first HTML element comprises determining if the first HTML string contains information corresponding to an ad dimension selected from the list of 468×60, 234×60, 88×31, 120×90, 120×60, 120×240, 125×125, 160×600, 300×250, 250×250, 240×400, 336×280, 180×150, 728×90 and 1×1.

13. The add-on in claim 8 wherein the method it performs further comprises determining if the first HTML string contains information related to a particular sequence of characters.

14. The add-on in claim 13 wherein the wherein the particular sequence is one selected from the list of “ad_frame”, “ad_banner”, “ad”, “default_ad”, “page_ad”, “ad_url” and “banner”.

15. A method of modifying a document associated with a browser, the document having first text visible when the document is displayed by the browser and the document having a URI, the method comprising:
if the URI of the document contains a first character sequence, modifying the document such that a portion of the first text will not be visible when the document is displayed by the browser; and
adding second text to the document, the second text visible when the document is displayed by the browser.

16. The method of claim 15 where modifying the document comprises setting a property of an HTML element.

17. The method of claim 15 where the first character sequence is one selected from the list of: “search”, “search?”, “results”, “results?”, “goggle”, “yehoo”, and “life”.

18. The method of claim 15 wherein the second text is obtained from a second URI.
